(19) United States
(12) Patent Application Publication
(10) Pub. No.: US 2006/0237493 A1
(43) Pub. Date: Oct. 26, 2006

(54) Baby sling

(76) Inventor: Yi-Hung Tsai, Taipei (TW)

Correspondence Address: HERSHKOVITZ & ASSOCIATES, 2845 DUKE STREET, ALEXANDRIA, VA, 22314, US

(21) Appl. No.: 11/393,842

(22) Filed: Mar. 31, 2006

(30) Foreign Application Priority Data
Apr. 15, 2005 (TW) 094205886

(51) Int. Cl. A61G 1/00

(52) U.S. Cl. 224/159

(57) ABSTRACT

A baby sling has two buckle rings and a sling body. The buckle rings are annular. The sling body passes over the buckle rings and has a fixed loop portion, a stitch, a supporting portion, a pocket and a tail portion. The fixed loop portion extends over the buckle rings and has two ends. The stitch is sewed on the ends of the fixed loop portion to fix the buckle rings onto the fixed loop portion. The supporting portion has two ends, an outer surface and two edges. One end of the supporting portion connects with one end of the fixed loop portion. The pocket is formed on the outer surface of the supporting portion near the fixed loop portion. The tail portion connects with the other end of supporting portion. The sling body can be folded into the pocket, so carrying the baby sling is convenient.

### BACKGROUND OF THE INVENTION

1. Field of the Invention

The present invention relates to a baby carrier, and especially to a baby sling for being conveniently collapsed and carried.

2. Description of the Related Art

Because babies cannot walk when they are just born, adults must carry and take care of them at any time. The adult cannot accomplish their task and is tired with the arms due to holding the baby, so that a baby sling is used for holding a baby. A conventional baby sling comprises a strap and two rings. The strap comprises two tails and a middle portion on which the rings are secured. A user wears the strap on one of the shoulders, and the tails are extended through the rings to secure the tails onto the middle portion. A baby can sit or lie on the strap, such that the user can accomplish the task and take care of the baby at the same time.

However, the conventional baby sling is easy in a mess and is not convenient to be carried after ripping the baby sling from the shoulder.

### SUMMARY OF THE INVENTION

The objective of the present invention is to provide a baby sling for conveniently collating and carrying.

To achieve the foregoing objective, a baby sling has two buckle rings and a sling body. The buckle rings are annular. The sling body passes over the buckle rings and has a fixed loop portion, a stitch, a supporting portion, a pocket and a tail portion. The fixed loop portion extends over the buckle rings and has two ends. The stitch is sewed on the ends of the fixed loop portion to fix the buckle rings onto the fixed loop portion. The supporting portion has two ends, an outer surface and two edges. One end of the supporting portion connects with one end of the fixed loop portion. The pocket is formed on the outer surface of the supporting portion near the fixed loop portion. The tail portion connects with the other end of supporting portion. The sling body can be folded into the pocket, so that carrying the baby sling is convenient.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a baby sling in accordance with the present invention;

FIG. 2 is an operational perspective view of the baby sling in FIG. 1 showing that an adult wears the baby sling and carries a baby with the baby sling;

FIG. 3 is a perspective view of the baby sling in FIG. 1 showing that the baby sling is folded to a pocket; and

FIG. 4 is a side view in partial section of the baby sling in FIG. 3.

### DETAILED DESCRIPTION OF THE PREFERRED EMBODIMENTS

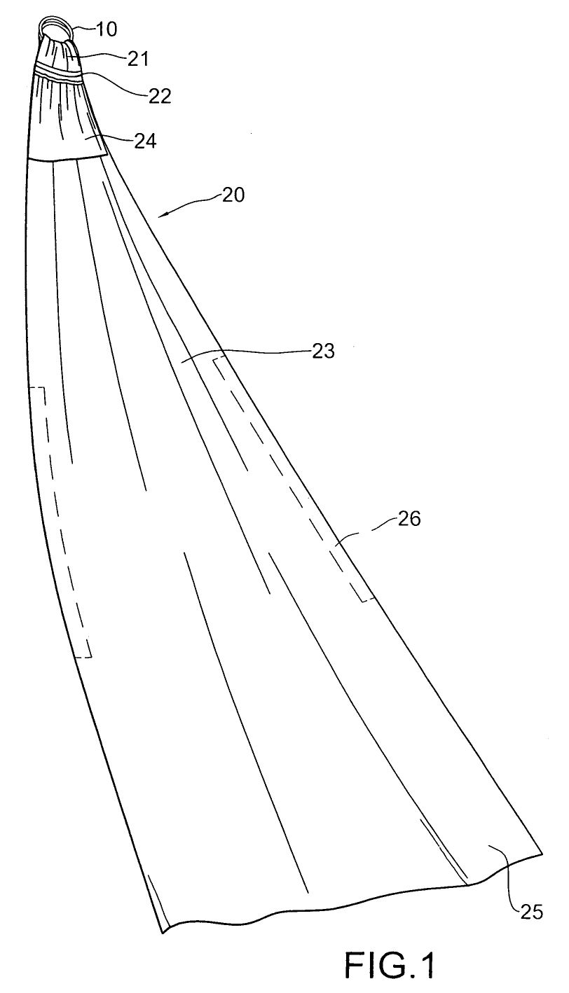

With reference to FIG. 1, a baby sling in accordance with the present invention comprises two buckle rings (10) and a sling body (20).

The buckle rings (10) are annular.

The sling body (20) extends over the buckle rings (10) and comprises a fixed loop portion (21), a stitch (22), a supporting portion (23), a pocket (24), a tail portion (25) and two optional cushions (26). The fixed loop portion (21) extends over the buckle rings (10) and comprises two ends. The stitch (22) is sewed on the ends of the fixed portion (21) to fix the buckle rings (10) onto the fixed loop portion (21). The supporting portion (23) comprises two ends, an outer surface and two edges. One end of the supporting portion (23) connects with one end of the fixed loop portion (21). The pocket (24) is formed on the outer surface of the supporting portion (23) near the fixed loop portion (21) and has an opening face toward the fixed loop portion (21). The tail portion (25) connects with the other end of supporting portion (23). The cushions (26) are respectively formed on the edges of the supporting portion (23).

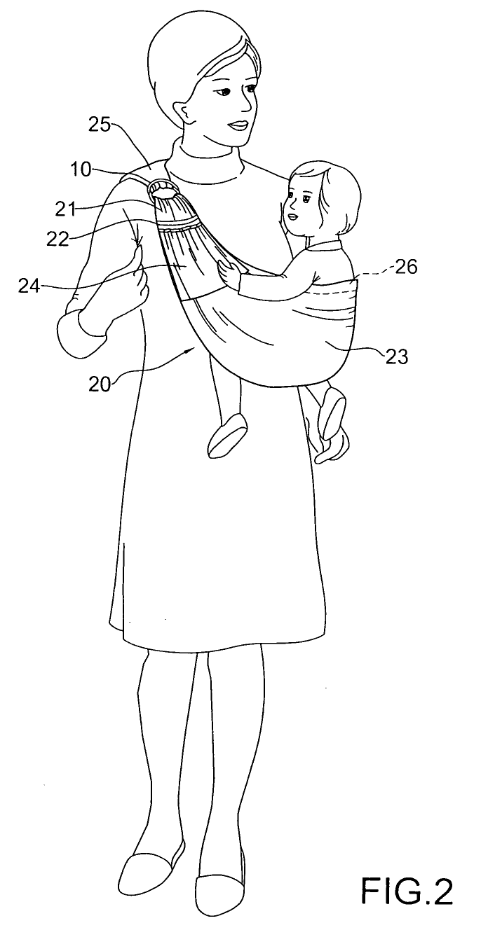

With further reference to FIG. 2, the tail portion (25) extends over the buckle rings (10) and is looped around one of the buckle rings (10) to be worn on a user. Consequently, the baby can sit or lie on the supporting portion (23). The user can keep two hands free to accomplish tasks and take cares the baby at the same time. In addition, the cushions (26) can provide a comforting effect to the baby held in the supporting portion (23).

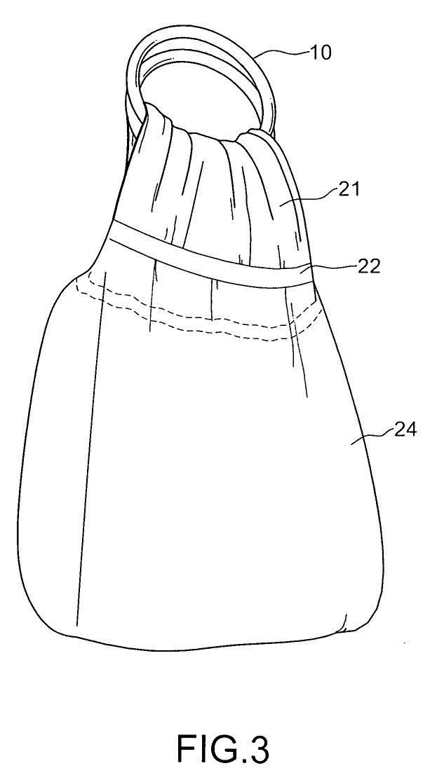

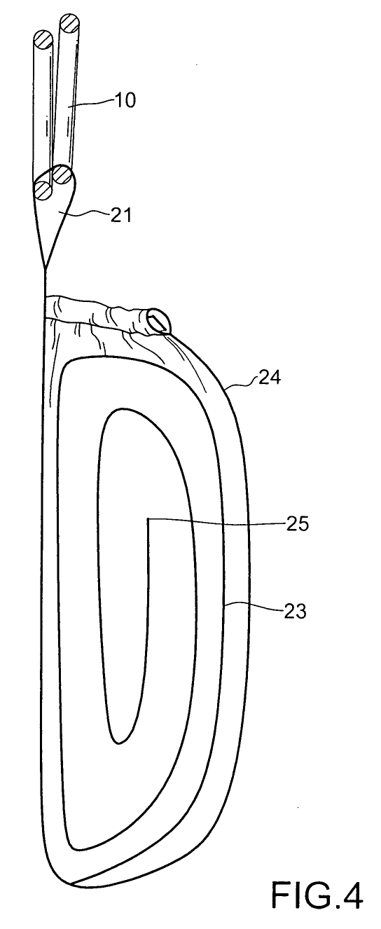

With reference to FIGS. 3 and 4, the baby sling is not in use, the tail portion (25) and the supporting portion (23) are folded and put into the pocket (24) in sequent to hold the tail portion (25) and the supporting portion (23) inside the pocket (24). Therefore, to carry or to fold the baby sling in accordance with the present invention is convenient.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A baby sling comprising
two buckle rings being annular; and
a sling body extending over the buckle rings and comprising
a fixed loop portion extending over the buckle rings and comprising two ends;
a stitch sewed on the ends of the fixed loop portion to fix the buckle rings onto the fixed loop portion;
a supporting portion connected with the fixed loop portion and comprising
two ends, wherein one end of the supporting portion is connected with one end of the fixed loop portion;
an outer surface; and
two edges;
a pocket formed on the outer surface of the supporting portion near the fixed loop portion; and
a tail portion connected with the other end of supporting portion.

2. The baby sling as claimed in claim 1, wherein the pocket has an opening facing toward the fixed loop portion.

3. The baby sling as claimed in claim 1, wherein the sling body comprises two cushions respectively formed on the edges of the supporting portion.
